(19) United States
(12) Patent Application Publication
(10) Pub. No.: US 2022/0286647 A1
(43) Pub. Date: Sep. 8, 2022

(54) ONLINE MEETING SYSTEM AND ONLINE MEETING CONTROL METHOD

(71) Applicant: Lenovo (Singapore) Pte. Ltd., Singapore (SG)

(72) Inventors: Kyohei Futami, Kanagawa (JP); Daisaku Morita, Kanagawa (JP)

(73) Assignee: Lenovo (Singapore) Pte. Ltd., Singapore (SG)

(21) Appl. No.: 17/581,151

(22) Filed: Jan. 21, 2022

(30) Foreign Application Priority Data
Mar. 2, 2021 (JP) 2021-032605

(51) Int. Cl. H04N 7/15; H04L 12/18

(52) U.S. Cl. CPC H04N 7/155; H04L 12/1831; H04L 12/1818

(57) ABSTRACT

An online meeting system is configured to include: an information processing device placed in each of seats; a playback device connected to the information processing device through a transmission line capable of transmitting source information of at least either one of video and voice to play back source information input through the transmission line; and a server device communicably connected to the information processing device, wherein the information processing device includes a source information transmission control unit which outputs source information received from the server device to the transmission line connected to the playback device, and the server device registers, in meeting registration information, seats specified to be used by participants of an online meeting and transmits the received source information to each of information processing devices associated with the seats registered in response to the online meeting.

### CROSS-REFERENCE TO RELATED APPLICATIONS

This application claims priority to Japanese Patent Application No. 2021-32605 filed Mar. 2, 2021, the contents of which are hereby incorporated herein by reference in their entirety.

### TECHNICAL FIELD

The present disclosure relates to an online meeting system and an online meeting control method.

### BACKGROUND

There is known a technique for an online meeting system in which terminal devices are connected to a network to make images shared among terminal devices in such a manner that the images can be displayed on the terminal devices.

### SUMMARY

In one or more embodiments of the present disclosure, a system includes a plurality of computers, each of the plurality of computers being placed at a respective one of a plurality of seats, a plurality of playback devices, each of the plurality of playback devices being connected to a respective one of the plurality of computers through a transmission line that transmits source information of at least either one of video and voice to play back source information input through the transmission line, and a server device communicably connected to each of the computers. Each of the plurality of computers includes a processor programmed to output source information received from the server device to the transmission line connected to the corresponding playback device, and the server device includes a processor programmed to: register, in meeting registration information, seats specified to be used by participants of an online meeting, and transmit the received source information to each of the information processing devices associated with the seats registered in response to the online meeting.

### BRIEF DESCRIPTION OF THE DRAWINGS

FIG. 1 is a diagram illustrating an overall configuration example of an online meeting system.

FIG. 2 is a diagram illustrating a configuration example of a single-board computer.

FIG. 3 is a diagram illustrating a configuration example of a meeting management server.

FIG. 4 is a diagram illustrating an example of a seat/single-board computer table.

FIG. 5 is a diagram illustrating an example of meeting registration information.

FIG. 6 is a flowchart illustrating an example of a processing procedure executed by the meeting management server in connection with holding an online meeting.

FIG. 7 is a flowchart illustrating an example of a processing procedure executed by the meeting management server in connection with streaming of a video content at the online meeting.

FIG. 8 is a diagram illustrating a form example of an online meeting.

### DETAILED DESCRIPTION

### First Embodiment

[Configuration Example of Online Meeting System]

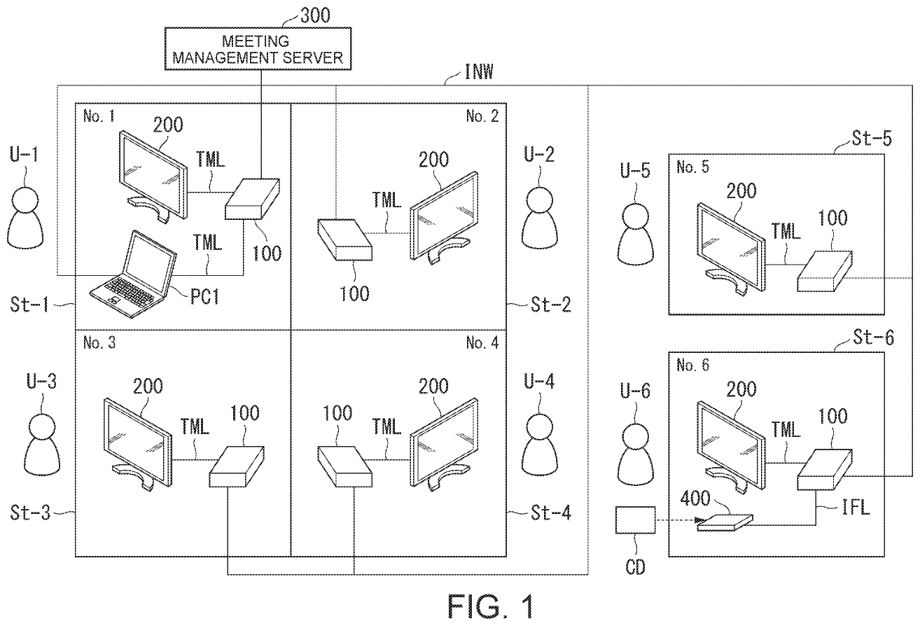

FIG. 1 is a diagram illustrating an overall configuration example of an online meeting system in a first embodiment.

The online meeting system of the present embodiment takes, as an example, a case of being used in a non-territorial office environment. The non-territorial office environment is an office form in which, for example, each employee is engaged in business by using any empty seat without allocating a fixed seat individually to the employee. The online meeting system of the present embodiment is used for employees to conduct an online meeting at an office in such a non-territorial office environment.

In FIG. 1, six seats St-1 to St-6 are illustrated among seats placed in an office. In FIG. 1, an example in which four seats St-1 to St-4 among the seats St-1 to St-6 are placed in a state of being gathered together, and the seats St-5 and St-6 are placed in positions away from the seats St-1 to St-4, respectively, is illustrated. In the present embodiment, although there is particularly no need to gather plural seats together, the example of gathering the seats St-1 to St-4 together is illustrated here.

In the following description, when the seats St-1 to St-6 are not particularly distinguished, the seats are described as the seats St.

In each of the seats St, one single-board computer 100 (an example of an information processing device) and a display device 200 (an example of a playback device) are placed, respectively. The pair of the single-board computer 100 and the display device 200 may also be fixedly placed in each of the seats St, respectively.

The single-board computer 100 and the display device 200 are connected through a video transmission line TML. For example, the video transmission line TML may correspond to the HDMI (High-Definition Multimedia Interface) standard. Further, the video transmission line TML may be a wired line or wireless channel.

The display device 200 displays video (an example of source information) input via the video transmission line TML.

A meeting management server 300 (an example of a server device) is provided, for example, corresponding to the office to execute control in order to realize the online meeting.

The meeting management server 300 is connected communicably to each of the single-board computers 100 via an intra-office network INW, respectively.

The meeting management server 300 in FIG. 1 is an example of an edge server provided corresponding to an online meeting in an office. Note that the meeting management server 300 may also be a server provided in the cloud.

As mentioned above, one single-board computer 100 is connected to the meeting management server 300 via the intra-office network INW, and connected to the display device 200 placed in the same seat St.

The single-board computer 100 can display, on the display device 200, a video transmitted form the meeting management server 300 by outputting the video received from the meeting management server 300 to the display device 200 via the video transmission line TML.

Further, the single-board computer 100 is equipped with ports corresponding to two or more video transmission lines TML. Thus, as illustrated in the seat St-1 of FIG. 1, when a device capable of video output such as a personal computer PC1 and the single-board computer 100 are connected through a video transmission line TML, a video output from the personal computer PC1 is input through the video transmission line TML.

The single-board computer 100 can display, on the display device 200, the input video by outputting the input video to the display device 200 via a video transmission line TML connected to the display device 200. Further, the single-board computer 100 can transmit the input video to the meeting management server 300 via the intra-office network INW. The meeting management server 300 can transmit (transfer) the video received from the one single-board computer 100 to the other single-board computers 100 via the intra-office network INW.

Further, the single-board computer 100 supports input/output of data via a data interface. The data interface supported by the single-board computer 100 is, for example, USB (Universal Serial Bus) or the like. Alternatively, the data interface supported by the single-board computer 100 may be near field communication such as Bluetooth (registered trademark).

In FIG. 1, an example in which the single-board computer 100 in the seat St-6 is connected to a card reader 400 through a data transmission line IFL that supports the data interface is illustrated. For example, the card reader 400 reads information recorded on an identification card CD such as an employee ID card, and outputs the read information to the single-board computer 100 via the data transmission line IFL. The single-board computer 100 can transmit the information input via the data transmission line IFL to the meeting management server 300 via the intra-office network INW.

Note that the information read by the card reader 400 from the identification card CD is used by the meeting management server 300 as information to identify an individual as a user to be described later. Therefore, any device other than the card reader 400 to acquire information (user authentication information) capable of identifying (authenticating) the individual as the user may also be connected to the single-board computer 100.

As the device to acquire the user authentication information mentioned above, for example, there can be a device capable of acquire biometric information, such as a camera for face authentication, a sensor for fingerprint authentication, a sensor for retina authentication, or a sensor for vein authentication.

When the meeting management server 300 identifies the user according to the user authentication information as mentioned above, the meeting management server 300 may store an authentication table in which authentication verification data registered for each user corresponding to each device is associated with the user. For example, when the authentication verification data corresponds to a sensor for fingerprint authentication, the authentication verification data may be information indicative of features about the fingerprint of the corresponding user.

The user authentication information acquired by the device is transmitted from the single-board computer 100 to the meeting management server 300 via the intra-office network INW. The meeting management server 300 can collate the received user authentication information with authentication verification data in the authentication table to identify the user.

[Configuration Example of Single-Board Computer]

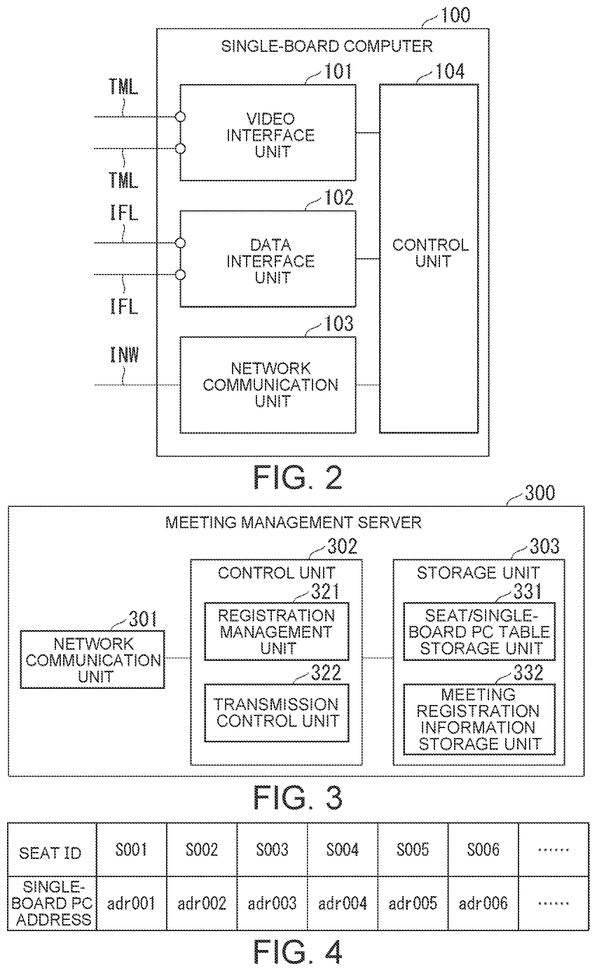

FIG. 2 illustrates a configuration example of the single-board computer 100. The single-board computer 100 in FIG. 2 includes a video interface unit 101, a data interface unit 102, a network communication unit 103, and a control unit 104 (an example of a source information transmission control unit).

The video interface unit 101 performs input and output of video through the video transmission line TML. In FIG. 2, the example in which the video interface unit 101 has two ports is illustrated, but the number of ports of the video interface unit 101 is not particularly limited.

The data interface unit 102 performs input and output of data through the data transmission line IFL that supports predetermined data interface standards. In FIG. 2, the example in which the data interface unit 102 has two ports, but the number of ports of the data interface unit 102 is not particularly limited.

The network communication unit 103 performs communication through the intra-office network INW. Note that the network communication unit 103 may also be able to be connected to a network outside the office.

The control unit 104 executes various controls on the single-board computer 100. The control unit 104 executes control related to input/output of video in the video interface unit 101. Further, the control unit 104 executes control related to input/output of data in the data interface unit 102. Further, the control unit 104 executes control related to communication in the network communication unit 103.

[Configuration Example of Meeting Management Server]

FIG. 3 illustrates a configuration example of the meeting management server 300. The meeting management server 300 in FIG. 3 includes a network communication unit 301, a control unit 302, and a storage unit 303.

The network communication unit 301 executes communication via the intra-office network INW. Note that the network communication unit 301 may also be connected to a network outside the office.

The control unit 302 executes various controls on the meeting management server 300. The control unit 302 includes a registration management unit 321 and a transmission control unit 322.

The registration management unit 321 manages meeting registration information. As will be described later, in response to the fact that a seat St used by a meeting participant is specified, the registration management unit 321 stores, in a meeting registration information storage unit 332, meeting registration information in which the specified seat St is associated with the corresponding single-board computer 100.

The transmission control unit 322 controls the transfer of video among single-board computers 100 at an online meeting. As will be described later, the transmission control unit 322 causes the transmission of a video content (source information), received from one single-board computer 100 among the single-board computers associated with the respective seats St registered for the same meeting, to the other single-board computers 100.

The storage unit 303 stores information supported by the meeting management server 300. The storage unit 303 includes a seat/single-board computer (single-board PC) table storage unit 331 and a meeting registration information storage unit 332.

The seat/single-board computer table storage unit 331 stores a seat/single-board computer table. The seat/single-board computer table is information indicative of the single-board computer 100 placed in each seat St in the office. In other words, the seat/single-board computer table is a table in which each placed board computer is associated with each seat St.

FIG. 4 illustrates an example of the seat/single-board computer table. The seat/single-board computer table in FIG. 4 has a structure in which the address of each single-board computer 100 (single-board computer address) is associated with each seat ID uniquely indicating each seat St placed in the office. In FIG. 4, each of seat IDs of S001 to S006 corresponds to each of the seats St-1 to St-6 in FIG. 1. Further, the single-board computer address is an address assigned to each corresponding single-board computer 100 on a network. For example, the meeting management server 300 can perform data transmission to each single-board computer 100 by using the single-board computer address as the destination in communication with the single-board computer 100. For example, the single-board computer address may be a MAC (Media Access Control) address or the like as long as the address can be used as the destination on the network.

The meeting registration information storage unit 332 stores meeting registration information. The meeting registration information is information indicative of the registration status of each of seats used by participants at a meeting. The meeting registration information storage unit 332 stores the meeting registration information for each set meeting. A specific example of the meeting registration information will be described later.

[Example of Online Meeting Holding Procedure]

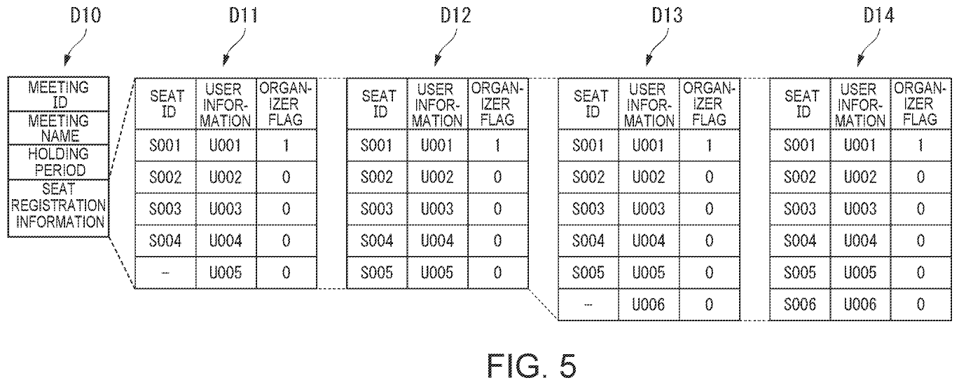

A procedure of holding an online meeting of the present embodiment will be described below. In the description, FIG. 5 is referred to together with FIG. 1 again.

In the following description, when users U-1 to U-6 in FIG. 1 are not particularly distinguished, the users are described as the users U.

Further, it is assumed that all participants view a video (video content) streamed by a user U as an organizer of an online meeting of the present embodiment described below particularly without any conversation among users U. Note that the video content may also include a voice synchronized with the video.

In holding the online meeting by the online meeting system having the above-mentioned configuration, the online meeting is registered at a stage before holding the online meeting. In the registration of the online meeting, for example, all the users U participating in the meeting may be authorized, but a case where only the user U as the organizer of the online meeting is authorized is taken as an example in the following description.

A case where the organizer of the online meeting is the user U-1 in FIG. 1 is taken as an example. The user U-1 as the organizer gets four participants of users U-2, U-3, U-4, and U-5 involved before holding the online meeting. In other words, in this case, the users determined to participate in the online meeting before holding the online meeting are five users in total, that is, the user U-1 as the organizer, and the four users of U-2, U-3, U-4, and U-5. Since the user U-6 is a user who joins in the middle of the online meeting, the description thereof will be omitted here.

When the online meeting is held among the user U-1 as the organizer and three users U-2, U-3, and U-4, use of the four seats St-1, St-2, St-3, and St-4 is confirmed. On the other hand, since it cannot be determined where the user U-5 is inside the office at the time of holding the online meeting though the user U-5 participates in the online meeting, the seat used by the user U-5 at the online meeting is in an undermined state.

In this case, the user U-1 as the organizer registers the seats as follows. For example, the user U-1 connects the own personal computer PC1 to the intra-office network INW to access the meeting management server 300. Thus, a meeting registration screen is displayed on the personal computer PC1.

The user U-1 first makes a new registration of the online meeting on the meeting registration screen displayed. At this time, the user U-1 specifies the name of the online meeting to be held, a time zone (start date and time, and end date and time), and the like, and performs an operation to register himself/herself (user U-1) as the organizer.

Then, the user U-1 registers the seats St-1, St-2, St-3, and St-4 as seat registration of the seats St used under the online meeting newly registered. At this time, the user U-1 performs an operation to register the seats St-1, St-2, St-3, and St-4 in association with respective users U.

As for the user U-5, the user U-1 performs an operation to register the user U-5 as a participant though the seat is undetermined (unregistered).

The registration of the online meeting at the stage so far is called a first registration stage.

In FIG. 5, an example of meeting registration information D10 created corresponding to one online meeting is illustrated. The meeting registration information D10 includes areas of meeting ID, meeting name, holding period, and seat registration information.

The area of meeting ID stores a meeting ID uniquely identifying the corresponding online meeting.

The area of meeting name stores a meeting name given to the corresponding online meeting.

The area of holding period stores a holding period (start date and time, and end date and time) set for the corresponding online meeting.

The area of seat registration information stores seat registration information. The seat registration information is information on seats use of which are registered under the corresponding online meeting.

In FIG. 5, a content example of seat registration information D11 corresponding to the first registration stage is illustrated.

The seat registration information D11 has a structure in which user information and organizer flag are associated with each seat ID. The seat ID is an identifier uniquely indicating the corresponding seat. The user information is information indicative of a corresponding user U. Specifically, for example, the user information may be the name of the user, or the like. The organizer flag is information indicating whether or not the user U indicated by the corresponding user information is the organizer. In the example of FIG. 5, it is indicated that the user is the organizer when the organizer flag is “1,” while it is indicated that the user is not the organizer when the organizer flag is “0.”

In the seat registration information D11, four seat IDs of S001 to S004 are stored. The seat IDs of S001 to S004 indicate the seats St-1 to St-4, respectively. The pieces of user information U001 to U004 are associated with the seat IDs of S001 to S004, respectively. The pieces of user information U001 to U004 correspond to the users U-1 to U-4, respectively.

Further, in the seat registration information D11, user information U005 is stored in addition to the user information U001 to U004. The user information U005 corresponds to the user U-5. However, any significant seat ID is not associated with the user information U005. By this association between the user information and the seat ID, it is indicated that the seat of the user U-5 used at the online meeting is undetermined though the participation of the online meeting is confirmed.

Further, in the seat registration information D11, “1” is stored as the organizer flag corresponding to the user information U001, and “0” is stored as the organizer flag corresponding to the remaining user information U002 to U005. By this organizer flag, it is indicated that the organizer of the online meeting is the user U-1.

In response to the fact that the registration up to the first registration stage has been made, meeting registration information D10 having the content of the seat registration information D11 is stored in the meeting registration information storage unit 332.

Thus, the registration of the online meeting in the present embodiment is to preregister (reserve) a seat St used by each user U who participates in the online meeting. On this basis, for example, when any seat St to be used cannot be determined by the time the online meeting is held, like the case of the user U-5, the user to participate can be registered while the seat St is unregistered.

It is assumed that the user U-5 was determined to use the seat St-5 upon participating in the online meeting shortly before the start of the online meeting after the first registration stage. It is then assumed that the user U-5 told the user U-1 as the organizer to use the seat St-5 at the online meeting. Therefore, the user U-1 displays, on the personal computer PC1, a meeting registration screen with the registration content of the first registration stage reflected thereon to perform an operation to associate the seat St-5 with the user U-5 registered as a participant. The registration of the online meeting at the stage so far is called a second registration stage.

By the registration at the second registration stage, the seat registration information D11 in FIG. 5 is updated to a content of seat registration information D12. The seat ID corresponding to the user information U005 is in the unregistered state in the seat registration information D11, while S005 is registered in the seat registration information D12. In other words, the seat registration information D12 is updated from the seat registration information D11 to indicate that the user U-5 is associated with the seat St-5.

At the online meeting, it is assumed that the user U-1 as the organizer streams a common video content to the users U participating in the online meeting, respectively. Therefore, the user U-1 makes the video content to be streamed playable on the own personal computer PC1. Then, the user U-1 connects the single-board computer 100 and the personal computer PC1 placed in the seat St-1 as the own seat through the video transmission line TML before the start time of the online meeting.

At this time, the same video content as that displayed on the personal computer PC1 is input to the single-board computer 100 in the seat St-1 through the video transmission line TML. The single-board computer 100 outputs the input video content to the display device 200 placed in the same seat St-1 through the video transmission line TML. Thus, the same video content as that displayed on the personal computer PC1 is displayed on the display device 200 placed in the seat St-1. Further, for example, when the display device 200 is equipped with a speaker or when a speaker is connected to the single-board computer 100, a voice synchronized with the video in the video content can be played back through the speaker.

Further, the single-board computer 100 transmits the input video content to the meeting management server 300 via the intra-office network INW. The meeting management server 300 can discard the video content being transmitted from the single-board computer 100 without particularly performing processing until the start time of the online meeting.

Further, the remaining users U-2 to U-5 participating in the online meeting sit down in own seats St-2 to St-5 while turning on the single-board computers 100 and the display devices 200, respectively, shortly before the start time of the online meeting.

Then, when the start time indicated in the holding period of the meeting registration information D10 comes, the meeting management server 300 starts steaming of the video content according to the online meeting.

In other words, the meeting management server 300 acquires the seat IDs indicated in the seat registration information stored in the meeting registration information D10. The meeting management server 300 acquires a single-board computer address corresponding to each of the acquired seat IDs, respectively, from the seat/single-board computer table stored in the seat/single-board computer table storage unit 331. In this case, the meeting management server 300 acquires five single-board computer addresses “adr001,” “adr002,” “adr003,” “adr004,” and “adr005.”

To the meeting management server 300, the video content is already transmitted from the single-board computer 100 in the seat St-1. In a packet of the transmitted video content, the single-board computer address “adr001” of the single-board computer 100 in the seat St-1 is included as sender information. In this case, the seat St corresponding to the single-board computer address as the sender of the video content is the seat St-1 registered in the seat registration information of the meeting registration information. In this case, the meeting management server 300 can refer to the seat/single-board computer table and the meeting registration information to identify that the single-board computer 100 as the sender of the video content is that in the seat St-1 registered in the meeting registration information.

Thus, when receiving the video content transmitted from the single-board computer 100 in the seat St registered in the meeting registration information, the meeting management server 300 sets the receiving video content as a streaming video content at the online meeting. The meeting management server 300 specifies, as destinations, the board computer addresses corresponding respectively to the seats St other than the seat St-1 among the seats St registered in the meeting registration information to transmit the streaming video content from the network communication unit 301.

Thus, the streaming video content is transmitted respectively to the single-board computers 100 in the seats St-2 to St-5 corresponding to the board computer addresses “adr002” to “adr005.”

Each of the single-board computers 100 in the seats St-2 to St-5 receiving the streaming video content transmitted from the meeting management server 300 displays the streaming video content on the display device 200 connected through the video transmission line TML, respectively. Further, as described above, the video content input from the personal computer PC1 to the single-board computer 100 is already output on the display device 200 in the seat St-1.

As a result, the same video content as that displayed on the personal computer PC1 is displayed on the display device 200 in each seat St in which each user participating in the online meeting is sitting down.

Note that the meeting management server 300 may also transmit the video content to the single-board computer 100 in the seat St-1. In this case, the single-board computer 100 in the seat St-1 may output, to the display device 200, the video content transmitted from the meeting management server 300 without outputting the video content input from the personal computer PC1 to the display device 200.

At the online meeting of the present embodiment, the same video content can be played back at the same time on the display devices 200 placed in the seats St in which the users U as the meeting participants are sitting down, respectively. Thus, the users U as the meeting participants can view the same video content at the same time.

In the present embodiment, since the video content is played back on the display device 200 placed in the seat St in which each user U is sitting down, there is particularly no need for any user U other than the organizer who streams the video content to bring in a network terminal such as an own personal computer. Further, this leads to no need to use an application installed on the network terminal (there is no dependence on the application) in order to realize the online meeting of the present embodiment.

Further, there is no need for the network terminal of each user U to access the server or the like as the streaming source of the video content in order to view the video content in the online meeting of the present embodiment. Therefore, for example, it is also avoided that a failure occurs in the streaming of the video content due to the concentration of access to the server from many network terminals.

Further, in the example of FIG. 1, since the video content can be streamed completely within the range of the intra-office network INW, security against unauthorized intrusion from external networks can also be obtained.

Further, in the online meeting system of the present embodiment, a user U can participate in the online meeting in the middle of the online meeting.

It is assumed that the user U-6 was determined to participate in the online meeting in the middle of the online meeting during streaming the video content at the online meeting as mentioned above by the determination of the user U as the organizer or by a request from the user U-6.

In this case, there are the following two methods for the user U-6 to join the online meeting part way through.

One method is that the user U-1 as the organizer uses the personal computer PC1 to get access to the meeting management server 300 via the intra-office network INW in order to additionally register, in the meeting registration information, a seat St used by the user U-6 at the online meeting and the user U-6 in association with each other.

The other method is to respond to a case where any seat St used by the user U-6 is not determined, for example, at a stage when the participation of the user U-6 was decided in the middle of the online meeting. In this case, the user U-1 as the organizer first uses the personal computer PC1 to get access to the meeting management server 300 via the intra-office network INW in order to additionally register, in the seat registration information of the meeting registration information, only the user U-6 without being associated with any seat St.

Seat registration information D13 in FIG. 5 illustrates an example of seat registration information in which the result of additional registration of the user U-6 is reflected as mentioned above. In the seat registration information D13, user information “U006” of the user U-6 is additionally registered, but any seat ID is not yet associated with the user information “U006.”

After that, it is assumed that the user U-6 decided to use the seat St-6. In this case, as illustrated in FIG. 1, the user U-6 connects the card reader 400 to the single-board computer 100 placed in the seat St-6 through the data transmission line IFL. The user U-6 causes the card reader 400 connected to the single-board computer 100 to read the identification card CD. On the identification card CD, information of the user U-6 as an employee (employee information) is stored. The card reader 400 reads the employee information from the identification card CD and outputs the read employee information to the single-board computer 100.

When the employee information is input via the data transmission line IFL, the single-board computer 100 transmits, to the meeting management server 300, a meeting participation request including the input employee information.

When receiving the meeting participation request, the meeting management server 300 searches the meeting registration information for user information of the user U-6 identical to that of the employee information included in the received meeting participation request. In the searched meeting registration information, a seat ID to be associated with the user U-6 is in the unregistered state.

Therefore, the meeting management server 300 acquires, from the seat/single-board computer table, a seat ID of “S006” corresponding to the seat associated with the single-board computer address of the single-board computer 100 as a sender of the received meeting participation request. As illustrated in seat registration information D14 of FIG. 5, the meeting management server 300 registers the acquired seat ID of “S006” in association with the user information “U006” of the user U-6.

Thus, in the meeting registration information, the user information is first registered, and the seat ID can be additionally registered in association with the user information when the meeting participation request transmitted from the single-board computer 100 is received after the user information is registered.

In response to the fact that the seat ID has been additionally registered in the meeting registration information as mentioned above, the meeting management server 300 also transmits the video content being transmitted from the single-board computer 100 in the seat St-1 to the single-board computer 100 in the seat St-6 in addition to the single-board computers 100 in the seats St-2 to St-5.

Thus, since the video content is also transmitted to the single-board computer 100 in the seat St-6, the user U-6 who joined the online meeting part way through can view the video content played back on the display device 200 placed in the seat St-6.

Note that, in the case of the user U-6 mentioned above, the registration of the seat ID in the seat registration information in which the user information is already stored may be able to be made at a stage before the start of the online meeting by causing the card reader 400 connected to the single-board computer 100 to read the identification card CD.

[Processing Procedure Example]

An example of a processing procedure related to holding an online meeting and executed by the meeting management server 300 of the present embodiment will be described below.

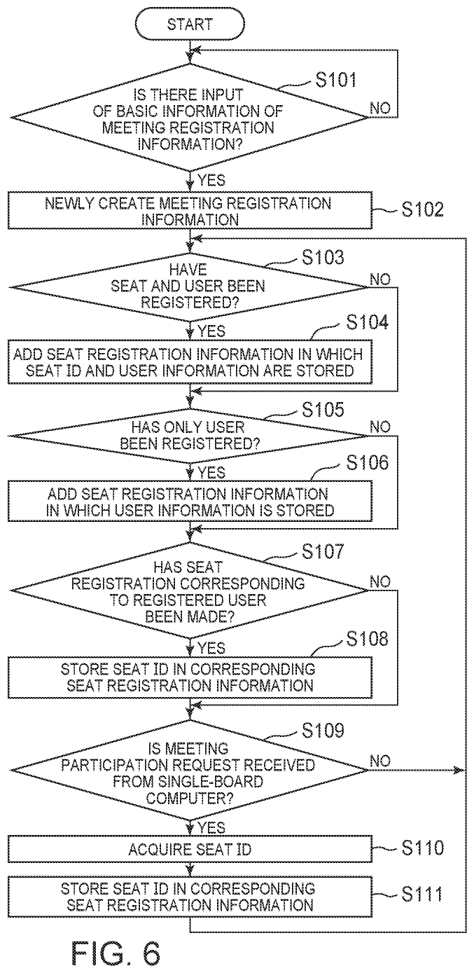

Referring to a flowchart of FIG. 6, an example of a processing procedure executed by the meeting management server 300 in connection with the management of meeting registration information will be described.

Step S101: As described above, the user U-1 as the organizer creates meeting registration information upon holding the online meeting. In creating the meeting registration information, the user U-1 as the organizer uses a network terminal to get access to the meeting management server 300 to input basic information such as that the organizer is the user U-1, the own seat (which may not be input if the seat is undermined), the meeting name, the holding period, and the like.

In the meeting management server 300, the registration management unit 321 is waiting for input of the basic information.

Step S102: In response to input of the basic information, the registration management unit 321 newly creates meeting registration information including the input basic information. The created meeting registration information may store in the meeting registration information storage unit 332.

Step S103: As described above, there is a case where seats St can be predetermined for users U participating in the meeting. In this case, the user U-1 as the organizer can register each seat St and each user in association with each other with an operation to the network terminal used to get access to the meeting management server 300 as in the case of registering the users U-2 to U-4 described above.

Therefore, after the process of step S102, the registration management unit 321 determines whether or not any registration operation to associate the seat St and the user has been performed.

Step S104: When determining in step S103 that the registration operation to associate the seat St and the user has been performed, the registration management unit 321 adds, to the meeting registration information, seat registration information in which a seat ID of the seat St specified with the registration operation and user information of the user specified with the registration operation are stored in association with each other.

Step S105: Further, as described above, the user U-1 as the organizer can register only a user without being associated with a seat St as in the above-described cases where the users U-5 and U-6 have been registered as the registration of the seat registration information.

Therefore, when determining in step S103 that no registration operation is performed, or after the process of step S104, the registration management unit 321 determines whether or not an operation to register only the user has been performed.

Step S106: When determining in step S105 that the operation to register only the user has been performed, the registration management unit 321 stores user information of the registered user, and adds, to the meeting registration information, seat registration information without any corresponding seat ID stored.

Step S107: Further, the user U-1 as the organizer can register a corresponding seat in seat registration information after only the user information is preregistered as in the case of registering the user U-5 described above.

Therefore, when determining that the operation in step S105 is not performed, or after the process of step S106, the registration management unit 321 determines whether or not an operation to resister a seat corresponding to the seat registration information in which only the user information is stored has been performed.

Step S108: When determining in step S107 that the operation to register a seat St corresponding to the seat registration information in which only the user information is stored has been performed, the registration management unit 321 stores, in the corresponding seat registration information, a seat ID of the seat St registered with the operation.

Step S109: Further, as in the case of the user U-6 described above, at the stage when the seat used at the online meeting by the user U already registered as a participant in the meeting registration information is decided, the seat can be registered by causing the card reader 400 connected to the single-board computer 100 to read the identification card CD. As described above, in response to the fact that the card reader 400 has read the identification card CD, the single-board computer 100 connected to the card reader 400 transmits, to the meeting management server 300, the meeting participation request including employee information read from the identification card CD.

Therefore, when determining that the operation in step S107 is not performed, or after the process of step S108, the registration management unit 321 determines whether or not the meeting participation request transmitted from the single-board computer 100 is received. When determining that the meeting participation request is not received, the procedure returns to the process in step S103.

Step S110: When determining in step S109 that the meeting participation request is received, the registration management unit 321 acquires, from the seat/single-board computer table, a seat ID associated with the single-board computer address of the single-board computer 100 as the sender of the meeting participation request received.

Step S111: The seat ID acquired in step S110 is stored in seat registration information in which user information of the same user as indicated by the employee information included in the meeting participation request received in step S109 is stored.

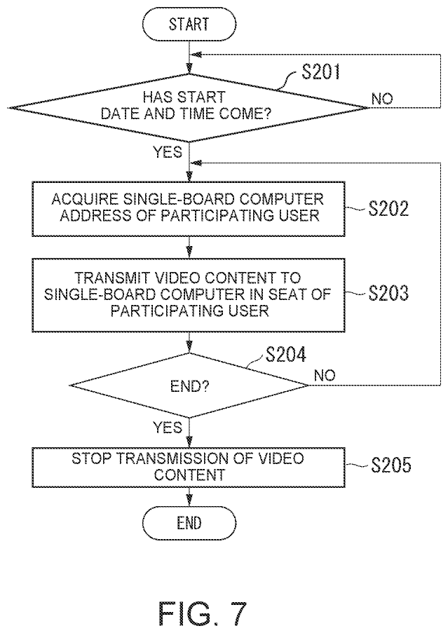

Referring to a flowchart of FIG. 7, an example of a processing procedure executed by the meeting management server 300 of the present embodiment in connection with streaming of a video content at an online meeting will be described.

Step S201: In FIG. 7, the transmission control unit 322 of the meeting management server 300 is waiting for the start time of the online meeting indicated in the information of the holding period in the meeting registration information.

Step S202: When it is determined in step S201 that the start time has come, the transmission control unit 322 acquires the single-board computer address of the single-board computer 100 of each user U participating in the corresponding online meeting. In other words, the transmission control unit 322 acquires each seat ID stored in the seat registration information of the meeting registration information. Then, the transmission control unit 322 acquires a single-board computer address associated with the acquired seat ID from the seat/single-board computer table. Thus, the single-board computer address of the single-board computer 100 of each user U participating in the online meeting is acquired.

Step S203: The transmission control unit 322 executes the transmission of a video content to the single-board computer 100 placed in the seat St of the user U participating in the online meeting.

In a state after the online meeting is started, for example, a user U as the organizer is outputting, to the single-board computer 100, a video content being played back on the personal computer PC1 in the own seat St.

Therefore, in S203, the transmission control unit 322 identifies a video content from the single-board computer address acquired in step S202 as a sender from among video contents being currently received by the network communication unit 301. The transmission control unit 322 inputs the identified video content as a streaming video content.

The transmission control unit 322 transmits the input streaming video content to single-board computer addresses except the single-board computer address as the sender of the streaming video content among the single-board computer addresses acquired in step S202.

Step S204: The transmission control unit 322 determines whether or not the online meeting is ended. For example, the transmission control unit 322 may determine that the online meeting is ended when the end date and time indicated by the information of the holding period in the meeting registration information has come. Alternatively, the organizer may connect a network terminal such as the personal computer PC1 to the meeting management server 300 via the intra-office network INW to be able to perform an operation to give an instruction to end the online meeting. Then, the transmission control unit 322 may determine the end of the online meeting in response to receiving a meeting end command according to the operation to give the instruction to end the online meeting.

When determining that the online meeting is not ended, the procedure returns to the process in step S202.

Step S205: When determining that the online meeting is ended, the transmission control unit 322 stops the transmission of the video content so far.

### Second Embodiment

Next, a second embodiment will be described. The first embodiment is to respond to such an online meeting form that a video content is streamed from one user U to the other users U. On the other hand, the second embodiment is to respond to a form of proceeding with an online meeting while having a conversation among participating users U.

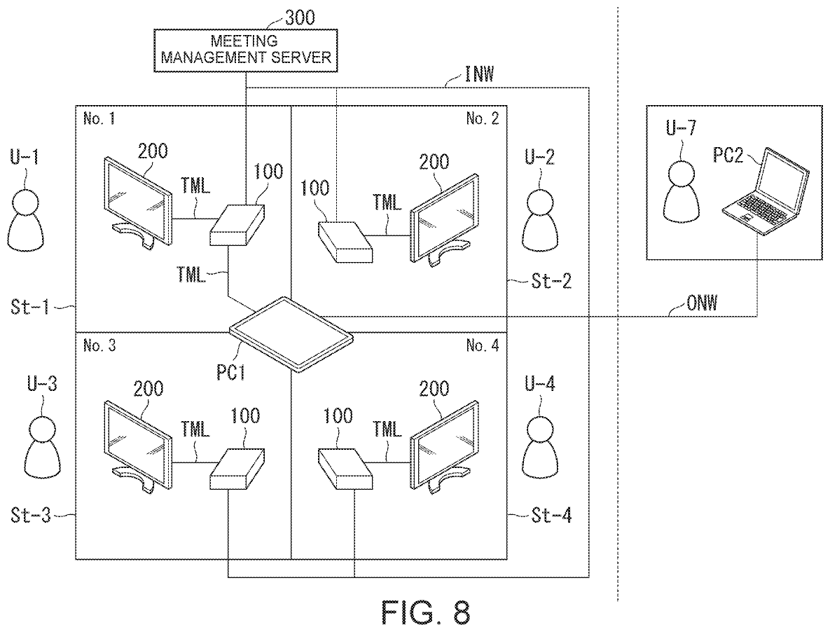

FIG. 8 illustrates a configuration example of an online meeting system corresponding to the form of the online meeting of the present embodiment. In FIG. 8, the same components as those in FIG. 1 are given the same reference numerals, and the description thereof is omitted as appropriate.

Even in the present embodiment, the case where the user U-1 is the organizer is taken as an example. It is assumed that the user U-1 holds the online meeting among five users in total, that is, the user U-1, and users U2 to U4 and U7. The user U-1 participates in the online meeting from inside the office.

It is then assumed that the user U-1 as the organizer has notified the users U2 to U4 and U7 to hold the online meeting. In response to the notification, it is assumed that the user U-1 as the organizer got answers to participate in the online meeting inside the office from three users U2 to U4. It is further assumed that the user U-1 got an answer to participate at home outside the office from the user U7.

Further, it is assumed that the user U-1 as the organizer who got the answers as mentioned above decided to use four seats St-1 to St-4 gathered together for four people including the user U-1 and the users U2 to U4 at the online meeting.

In this case, the user U-1 as the organizer causes the own personal computer PC1 to access the meeting management server 300 in order to register meeting registration information on the following content. Namely, the user U-1 as the organizer performs an operation to input the same basic information as in the first embodiment. Then, the user U-1 as the organizer performs operations to specify four seats St-1 to St-4 and register the seats in a manner as to associate the seats St-1 to St-4 with the users U-1 to U-4, respectively.

According to such registration operations, the meeting registration information created by the meeting management server 300 and stored in the meeting registration information storage unit 332 has the same content as a content obtained by deleting the bottom seat registration information corresponding to the user U-5 from the seat registration information D11 in FIG. 5.

Since the user U-7 who participates in the online meeting at home does not use any seat St inside the office, the seat does not have to be registered in the seat registration information of the meeting registration information. At the online meeting of the present embodiment, the personal computer PC1 of the user U-1 as the organizer and a personal computer PC2 of the user U-7 are connected via an external network ONW to perform communication with each other, for example, by using an external network-enabled online meeting application (or an online meeting service via a web browser). Note that the illustration of an online meeting server on the external network ONW is omitted in FIG. 8.

In other words, the personal computer PC1 and the personal computer PC2 on which the external network-enabled online meeting application runs, respectively, transmit voices collected by respective built-in (or connected) microphones to each other. Then, the personal computer PC1 and the personal computer PC2 output the received voices from respective built-in (or connected) speakers or the like.

Further, the personal computer PC1 and the personal computer PC2 on which the external network-enabled online meeting application runs, respectively, transmit captured images captured with respective built-in (or connected) cameras to each other. The personal computer PC1 and the personal computer PC2 display the received captured images on respective display units.

At the start of the online meeting, the user U-1 and the user U-7 connect the personal computer PC1 and the personal computer PC2 by the external network-enabled online meeting application.

Further, the user U-1 sets the personal computer PC1 in a meeting mode. The meeting mode is a mode to make the personal computer PC1 shareable among plural users at the online meeting. The personal computer PC1 has a foldable display unit. In the meeting mode, for example, the chassis of the personal computer PC1 is opened at 180 degrees to be able to provide a display in a state where the display unit is unfolded.

In this case, the personal computer PC1 is located in the center of the seat St-1 to the seat St-4 gathered together. Thus, all the users U-1 to U-4 can listen evenly to the voice output from the personal computer PC1.

Further, the personal computer PC1 is connected to the single-board computer 100 placed in the seat St-1 through the video transmission line TML.

When the start time of the online meeting has come, the user U-1 and the user U-7 start an external network-enabled online meeting between the personal computer PC1 and the personal computer PC2.

On each of the display units of the personal computer PC1 and the personal computer PC2, a video of the external network-enabled online meeting is displayed, respectively. Further, the video displayed on the display unit of the personal computer PC1 is output to the single-board computer 100 in the seat St-1 via the video transmission line TML.

The single-board computer 100 in the seat St-1 outputs the video input from the personal computer PC1 to the display device 200 in the same seat St-1 through the video transmission line TML. Further, the single-board computer 100 in the seat St-1 transmits, as a streaming video content, the video input from the personal computer PC1 to the meeting management server 300 via the intra-office network INW.

When the start time indicated in the holding period of the meeting registration information has come, the meeting management server 300 transmits the streaming video content being transmitted from the single-board computer 100 in the seat St-1 to each of the single-board computers 100 in the seats St-2 to St-4, respectively, based on the seat registration information in the meeting registration information.

Each of the single-board computers 100 in the seats St-2 to St-4 outputs the received streaming video content to the display device 200 placed in the same seat St via the video transmission line TML, respectively.

When the online meeting is started as mentioned above, the same video as that being displayed on the personal computer PC1 is displayed on the display devices 200 in the seats St-1 to St-4 in which the users U-1 to U-4 are sitting down in the office, respectively. In other words, the video of the external network-enabled online meeting via the external network connected to the user U-7 is displayed on each of the display devices 200 in the seats St-1 to St-4, respectively. Thus, the users U-1 to U-4 participating in the online meeting at the office can view the video of the external network-enabled online meeting on the display devices 200 in the own seats, respectively.

Further, the voice emitted by the user U-7 is output from the speaker of the personal computer PC1. Further, voices emitted by the users U-1 to U-4 are collected by the microphone of the personal computer PC1, and transmitted to the personal computer PC2 by the external network-enabled online meeting application.

Thus, the users U-1 to U-4 participating in the online meeting at the office can proceed with the online meeting while having a conversation with the user U-7 participating at home.

Note that the online meeting system in each of the aforementioned embodiments is to stream a video. However, the meeting management server 300 may also stream a voice instead of the video.

In this case, the single-board computer 100 in each seat St is connected to an audio playback device such as an active speaker through an audio transmission line.

Then, one of users U participating in the online meeting inputs, to the single-board computer 100 in the own seat through the audio transmission line, a voice output from a terminal such as a personal computer or an IC recorder.

The single-board computer 100 that received the voice input transmits the input voice to the meeting management server 300. Further, the single-board computer 100 that received the voice input outputs the input voice to the audio playback device placed in the same seat St through the audio transmission line.

The meeting management server 300 transmits (streams) the received voice to the single-board computers 100 in seats St corresponding to the users U participating in the online meeting based on the seat registration information of the meeting registration information. Each of the single-board computers 100 that received the voice outputs the received voice to the audio playback device placed in the same seat St through the audio transmission line, respectively.

Thus, each of the users participating in the online meeting can listen to a streaming voice played back by the audio playback device in the own seat, respectively.

While the embodiments of this disclosure have been described above with reference to the accompanying drawings, the specific configurations are not limited to the aforementioned embodiments, and include design changes and the like without departing from the scope of this disclosure. Further, the respective configurations described in the aforementioned embodiments can be combined arbitrarily as long as there is no contradiction. Accordingly, the scope of the invention should be limited only by the attached claims.

1. A system comprising:
a plurality of computers, each of the plurality of computers being disposed at a respective one of a plurality of seats;
a plurality of playback devices, each of the plurality of playback devices being connected to a respective one of the plurality of computers through a transmission line that transmits source information of at least one of video and voice to play back source information input through the transmission line; and
a server device communicably connected to each of the computers, wherein
each of the plurality of computers includes a processor that outputs source information, received from the server device, to the transmission line connected to the corresponding playback device, and
the server device includes a processor that:
registers, in meeting registration information, seats specified to be used by participants of an online meeting, and
transmits the received source information to each of the information processing devices associated with the seats registered in response to the online meeting.

2. An online meeting system comprising:
an information processing device being disposed at each of a plurality of seats;
a playback device connected to the information processing device through a transmission line that transmits source information of at least one of video and voice to play back source information input through the transmission line; and
a server device communicably connected to the information processing device, wherein
the information processing device includes a source information transmission control unit which outputs source information received from the server device to the transmission line connected to the playback device, and
the server device includes:
a registration management unit which registers, in meeting registration information, a plurality of seats specified to be used by participants of an online meeting; and
a transmission control unit which transmits the received source information to each information processing device associated with the plurality of seats registered in response to the online meeting.

3. The online meeting system according to claim 2, wherein the registration management unit registers, in the meeting registration information, each of the participants of the online meeting in a manner to be able to register each registered participant in association with each seat.

4. The online meeting system according to claim 2, wherein the source information transmission control unit transmits, to the server device, source information input from a terminal connected through a transmission line capable of transmitting source information of at least one of video and voice.

5. An online meeting control method for an online meeting system including: an information processing device disposed in each of a plurality of seats; a playback device connected to the information processing device through a transmission line capable of transmitting source information of at least one of video and voice to play back source information input through the transmission line; and a server device communicably connected to the information processing device, the online meeting control method comprising:
outputting, by the information processing device, source information received from the server device to the transmission line connected to the playback device;
registering, by the server device, seats specified to be used by participants of an online meeting, wherein the seats are registered in meeting registration information; and
transmitting, by the server device, the received source information to each of information processing devices associated with the seats registered in response to the online meeting.
